(19) United States
(12) Patent Application Publication
(10) Pub. No.: US 2022/0035169 A1
(43) Pub. Date: Feb. 3, 2022

(54) CONNECTOR FOR PERIPHERAL COMPONENT

(71) Applicant: Hewlett-Packard Development Company, L.P., Spring, TX (US)

(72) Inventors: Keith Eiler, Fort Collins, CO (US); Robert P. Martin, Fort Collins, CO (US); Nathan Nuber, Fort Collins, CO (US)

(73) Assignee: Hewlett-Packard Development Company, L.P., Spring, TX (US)

(21) Appl. No.: 17/298,553

(22) PCT Filed: Mar. 20, 2019
(86) PCT No.: PCT/US2019/023147

§ 371 Date: May 29, 2021

(51) Int. Cl. G02B 27/01; G06F 13/40; G06F 13/42

(52) U.S. Cl. CPC G02B 27/0176; G06F 2213/0042; G06F 13/4282; G06F 13/4068

(57) ABSTRACT

A connector to interface between a head-mounted display (HMD) device and a computing device is provided. The connector includes a housing, a first port positioned within the housing to receive a first cable that is connectable to the computing device and to exchange a first plurality of signals between the computing device and the HMD device, a second port positioned within the housing to receive a second cable that is connectable to the HMD device, the second port coupled with the first port to exchange the first plurality of signals between the computing device and the HMD device, and a third port positioned within the housing to receive a third cable that is connectable to a peripheral device, the third port coupled with the first port to exchange a second plurality of signals between the computing device and the peripheral device.

### BACKGROUND

A head-mounted display (HMD) device connects to a first cable to electrically communicate with an electronic device, such as a personal computer (PC). The HMD transmits/receives different types of data as well as power to/from the PC to provide a virtual or augmented reality experience for a user of the HMD. To enhance the experience, the user may incorporate a peripheral component with the HMD. However, the peripheral component also requires a connection to the PC for transmitting/receiving data or power, thus necessitating the need for a second cable. The need to provide the second cable between the peripheral device and PC may cause an inconvenience to the user.

### BRIEF DESCRIPTION OF DRAWINGS

Certain examples of the present disclosure will be more apparent from the following description taken in conjunction with the accompanying drawings, in which:

FIG. 1 is a view illustrating a head-mounted display (HMD) system including an HMD device and a peripheral component coupled with a connector, according to an example;

FIG. 2 illustrates an interface connector according to an example;

FIG. 3 illustrates an interface connector according to an example;

FIG. 4 illustrates an interface connector according to an example; and

FIG. 5 illustrates a connecting device according to an example.

Throughout the drawings, it should be noted that like reference numbers are used to depict the same or similar elements, features, parts, components, and structures.

### DETAILED DESCRIPTION OF EXAMPLES

Various examples will be described more fully hereinafter with reference to the accompanying drawings. The examples described hereinafter may be modified in many different forms. To more clearly describe features of examples, matters well known to one of ordinary skill in the art to which the below examples pertain may not be described in detail.

Throughout the description, when an element is referred to as being “connected” or “coupled” to another element, it can be directly connected or coupled to the other element, or can be connected or coupled to the other element with intervening elements interposed therebetween.

In the following description, a singular expression includes a plural expression, unless otherwise specified. It is also to be understood that terms such as “comprises” or “includes” are used herein to designate the presence of a characteristic, a number, a step, an operation, an element, a component, or a combination thereof, and not to preclude the presence or the possibility of adding one or more of other characteristics, numbers, steps, operations, elements, components, or a combination thereof. It is also to be understood that terms such as “first,” “second,” and the like are used to differentiate between objects having the same or similar terminology and are in no way intended to represent an order, unless where explicitly stated otherwise.

A head-mounted display (HMD) device can provide diverse experiences for a user. For example, an HMD device may provide a gaming environment or a virtual reality (VR) environment in which it may display computer generated or pre-recorded content. The HMD device may also provide a mixed or augmented reality (AR) environment in which it may project virtual content onto physical content.

In use, an HMD device may be connected to a computing device such as a gaming console, a personal computer (PC), a laptop computer, a tablet, a smartphone, or the like to exchange signals between the computing device and the HMD device. Examples of such signals may include a video signal, an audio signal, a control signal, a data signal, a power signal, or the like. To support the signal exchange, a multi-conductor cable is provided between the HMD device and the computing device. In an example, the connection between the HMD device and the computing device may be established using two cables. A shorter cable is electrically terminated and attached to the HMD device and has a connector for coupling with a longer cable. The longer cable has a first connector for coupling with the connector of the shorter cable and a second connector for plugging into one or more ports at the computing device. In implementation, the shorter cable may have a length of approximately 0.5 m while the longer cable has a length of approximately 4 m. However, these lengths may vary depending on parameters of the cable, such as those concerning signal strength and integrity.

To enhance an HMD experience, a user may incorporate a peripheral component, such as a hand gesture controller, a touch controller, an equipment emulator, a movement emulator, or the like. Because it is necessary for the peripheral component to also exchange signals with the computing device, the peripheral component may also be provided with a shorter cable attached to the peripheral component that connects to a longer cable for signaling with the computing device. However, in certain examples, the peripheral component is located nearby the HMD device, such as being attached to the HMD device. In such examples, a user may be inconvenienced by having one or more cables between the HMD device and the computing device and one or more additional cables between the peripheral component and the computing device. To address this inconvenience, an example of the invention expands the capability of the connection between the HMD device and the computing device by providing a path for signaling between the peripheral component and the computing device.

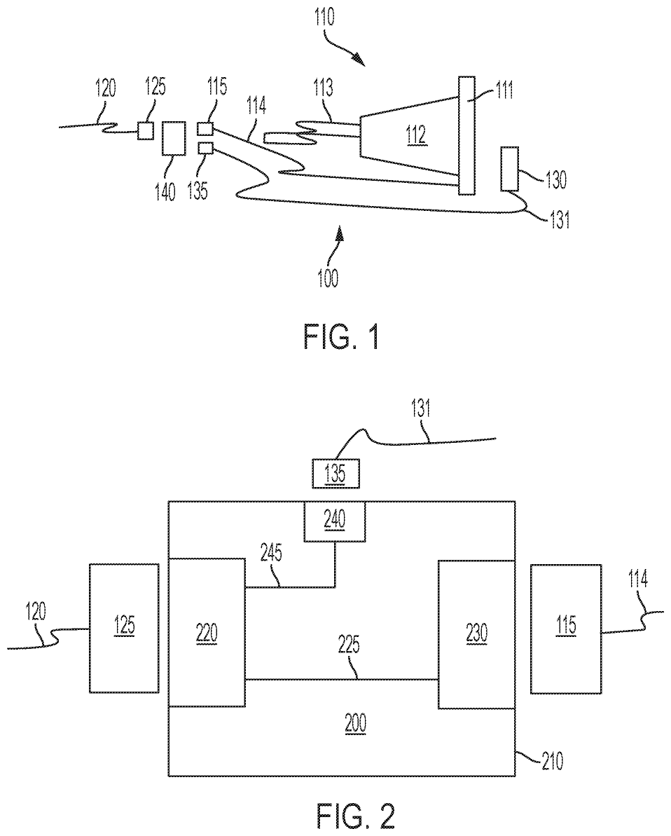

FIG. 1 is a view illustrating an HMD system including an HMD device and a peripheral component coupled with a connector, according to an example.

Referring to FIG. 1, an HMD system 100 may include an HMD device 110, a remote communication cable 120, a peripheral component 130, and an interface connector 140.

The HMD device 110 may include a display module 111, a housing 112, a mounting strap 113, and a local communication cable 114 that is coupled with a local connector 115. The HMD device 110 may be secured to a user's head with the mounting strap 113 to allow the user to view content on a screen of the display module 111. The display module 111 may have a screen including a liquid crystal display (LCD), a light emitting diode (LED) display, an active matrix organic LED (AMOLED) display, or the like to display content to the user. The HMD device 110 may display content in various formats and may display video, photos, computer-generated imagery (CGI), or the like. Although not shown, the HMD device 110 may also include an audio output mechanism such as a speaker, an earpiece, or the like to output an audio signal.

The local communication cable 114 is a multiple conductor cable that carries a first plurality of signals to and from the HMD device 110. For example, the local communication cable 114 may carry a video signal, an audio signal, a control signal, a data signal, a power signal, or the like to and from the HMD device 110. The local communication cable 114 is directly coupled to the HMD device 110 at a first end and includes the local connector 115 coupled to a second end.

The remote communication cable 120 is also a multiple conductor cable that carries signals to and from the computing device (not shown). The remote communication cable 120 includes a first end for connecting to the computing device and a second end that is coupled with a remote connector 125. The remote communication cable 120 with the remote connector 125 and the local communication cable 114 with the local connector 115 may be supplied by the manufacturer of the HMD device 110. In that case, the remote connector 125 and the local connector 115 may have the same form factor (e.g., connector dimension, pin configuration, etc.) such that they may physically and electrically connect to each other in order to exchange signals between the computing device and the HMD device 110.

The peripheral component 130 includes a peripheral cable 131, which is a multiple conductor cable that carries signals to and from the peripheral component 130. For example, the peripheral cable 131 may carry a second plurality of signals such as a video signal, an audio signal, a control signal, a data signal, a power signal, or the like to and from the peripheral component 130. The peripheral cable 131 is coupled with a peripheral connector 135.

To operate the peripheral component 130 with the HMD device 110, a first plurality of signals from the HMD device 110 and a second plurality of signals from the peripheral component 130 may be exchanged with the computing device. To support that signaling, a remote communication cable, similar to remote communication cable 120, may be coupled with the peripheral cable 131 to exchange signals with the computing device. However, a second remote communication cable may be an inconvenience to a user.

The interface connector 140 receives the local connector 115, the remote connector 125, and the peripheral connector 135 to exchange signaling between the HMD device 110 and the computing device and between the peripheral component 130 and the computing device. The interface connector 140 thus relieves the inconvenience of providing a second remote communication cable between the computing device and the peripheral component 130.

FIG. 2 illustrates an interface connector 200 according to an example.

Referring to FIG. 2, the interface connector 200 includes a housing 210. Located within the housing 210 are a first port 220, a first coupling 225, a second port 230, a third port 240, and a second coupling 245. The housing 210 of the interface connector 200 may include a connecting device such as a clip, a snap, or the like for securing the housing 210 of the interface connector 200 to the housing 112 of the HMD device 110.

The first port 220 is positioned within the housing 210 for coupling with a computing device (not shown). In that regard, the first port 220 may receive the remote connector 125 coupled with the remote communication cable 120 for exchanging signals with the computing device. For example, signals exchanged with the computing device may include one or more of a video signal, an audio signal, a control signal, a data signal, a power signal, or the like. The first port 220 may support any of various interface standards and may be implemented as one or more of an optical copper link (OCuLink) port, a high-definition multimedia interface (HDMI) port, a universal serial bus (USB) port, a displayport port, or the like in order to support the signals exchanged with the computing device.

The second port 230 is positioned within the housing 210 for coupling with an HMD device, such as the HMD device 110 of FIG. 1. In that regard, the second port 230 may receive the local connector 115 coupled with the local communication cable 114 for exchanging signals with the HMD device 110. For example, signals exchanged with the HMD device 110 may include one or more of a video signal, an audio signal, a control signal, a data signal, a power signal, or the like. The second port 230 may be one or more of an OCuLink port, an HDMI port, a USB port, a displayport port, or the like in order to support the first plurality of signals exchanged with the HMD device 110.

A first coupling 225 is provided between the first port 220 and the second port 230. The first coupling 225 may include a plurality of conductors to exchange signals between the first port 220 and the second port 230.

The third port 240 is positioned within the housing 210 for coupling with a peripheral component, such as the peripheral component 130 of FIG. 1. In that regard, the third port 240 may receive the peripheral connector 135 coupled with the peripheral communication cable 131 for exchanging signals with the peripheral component 130. For example, signals exchanged with the peripheral component 130 may include one or more of a video signal, an audio signal, a control signal, a data signal, a power signal, or the like. The third port 240 may be one or more of an OCuLink port, an HDMI port, a USB port, a displayport port, or the like in order to support the signals exchanged with the peripheral component 130.

A second coupling 245 is provided between the first port 220 and the third port 240. The second coupling 245 may include a plurality of conductors to exchange signals between the first port 220 and the third port 240.

The interface connector 200 provides for an exchange of a first plurality of signals between the computing device and the HMD device 110. For example, the interface connector 200 may receive the first plurality of signals from the computing device through the remote communication cable 120 and remote connector 125 at the first port 220. The first plurality of signals may be exchanged with the second port 230 through the first coupling 225 and provided to the local connector 115 coupled with the local communication cable 114. The first plurality of signals may be provided to the HMD device 110 through the local communication cable 114 and used by the display module 111 to provide a VR, AR, or similar experience for the user.

The interface connector 200 also provides for an exchange of a second plurality of signals between the computing device and the peripheral component 130. For example, the interface connector 200 may receive the second plurality of signals from the computing device through the remote communication cable 120 and remote connector 125 at the first port 220. The second plurality of signals may be exchanged with the third port 240 through the second coupling 245 and provided to the peripheral connector 135 coupled with the peripheral cable 131. The second plurality of signals may be provided to the peripheral component 130 through the peripheral cable 131 and used by the peripheral component to enhance the VR, AR, or similar experience for the user.

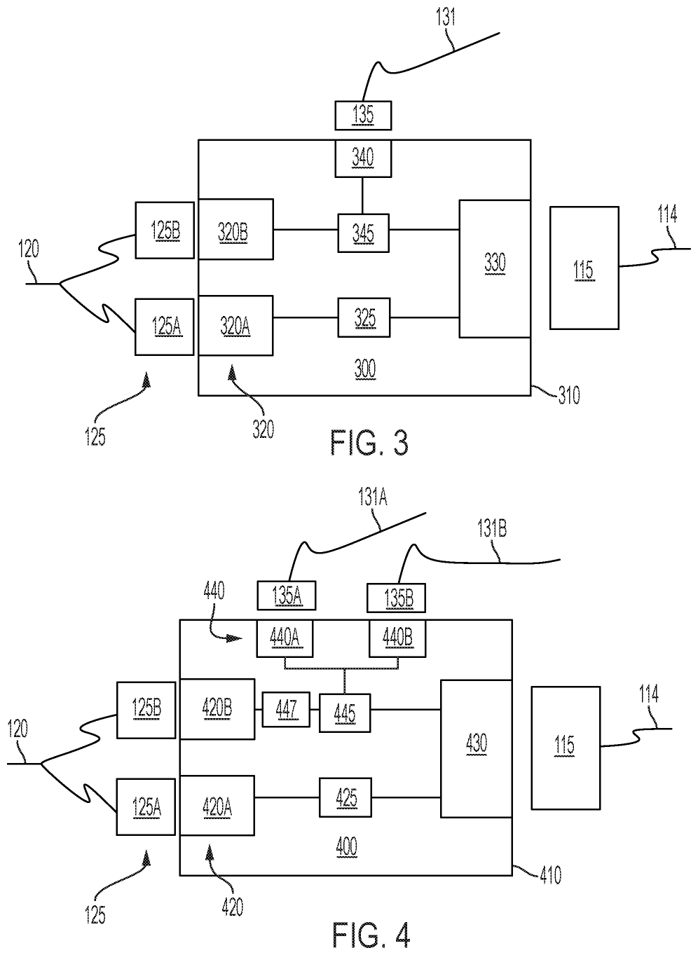

FIG. 3 illustrates an interface connector according to an example.

Referring to FIG. 3, an interface connector 300 includes a housing 310. Located within the housing 310 are a first port 320, a first coupling 325, a second port 330, a third port 340, and a second coupling 345. The housing 310 may include a connecting device for securing the housing 310 of the interface connector 300 to the housing 112 of the HMD device 110.

The first port 320 is positioned within the housing 310 for coupling with a computing device (not shown). In the example of FIG. 3, the first port 320 includes two ports 320A and 320B. The ports 320A and 320B may be selected based on signaling needs of the HMD device 110 and/or the peripheral component 130. For example, the port 320A may provide an interface to support one or more of an audio signal, a video signal, a control signal, a data signal, or the like. In that case, the port 320A may include an HDMI port, a displayport port, a digital visual interface (DVI) port, or the like. On the other hand, the port 320B may provide an interface to support one or more of a control signal, a data signal, a power signal, or the like. In that case, the port 320B may include a USB 2.0 port, a USB 3.0 port, or the like. Further, the port 320B may include a USB type A port, a USB type B port, a USB type C port, a USB mini port, a USB micro port, or the like.

In the example of FIG. 3 in which the first port 320 includes the ports 320A and 320B, the remote communication cable 120 may be implemented to include remote connectors 125A and 125B for respectively coupling with the ports 320A and 320B. In an example, the port 320A may be implemented as a displayport port while the port 320B may be implemented as a USB type A port. In that example, the connector 125A would include a displayport connector while the connector 125B would include a USB type A connector.

The second port 330 is positioned within the housing 310 for coupling with an HMD device, such as the HMD device 110 of FIG. 1. In that regard, the second port 330 may receive the local connector 115 coupled with the local communication cable 114 for exchanging signals with the HMD device 110. For example, signals exchanged with the HMD device 110 may include one or more of a video signal, an audio signal, a control signal, a data signal, a power signal, or the like. The second port 330 may be one or more of an OCuLink port, an HDMI port, a USB port, a displayport port, or the like in order to support the first plurality of signals exchanged with the HMD device 110.

The first coupling 325 is provided between the first port 320 and the second port 330. In the example of FIG. 3, the first coupling 325 is provided between the port 320A and the second port 330. The first coupling 325 may include a plurality of conductors to exchange signals between the first port 320 and the second port 330. Furthermore, the first coupling 325 may include a repeater or other circuitry to amplify or otherwise improve the quality of a signal received at the port 320A. For example, the first coupling 325 may include re-driver circuitry to enhance the quality of a signal received at the port 320A. The improved signal is output from the first coupling 325 and provided to the HMD device 110 through the second port 330, the local connector 115, and the local communication cable 114.

The third port 340 is positioned within the housing 310 for coupling with a peripheral component, such as the peripheral component 130 of FIG. 1. In that regard, the third port 340 may receive the peripheral connector 135 coupled with the peripheral communication cable 131 for exchanging signals with the peripheral component 130. For example, signals exchanged with the peripheral component 130 may include one or more of a video signal, an audio signal, a control signal, a data signal, a power signal, or the like. The third port 340 may be one or more of an OCuLink port, an HDMI port, a USB port, a displayport port, or the like in order to support the signals exchanged with the peripheral component 130.

The second coupling 345 is provided between the first port 320 and the third port 340. In the example of FIG. 3, the second coupling is provided between the port 320B and the third port 340 as well as between the port 320B and the second port 330. The second coupling 345 may include a plurality of conductors to exchange signals between the port 320B and the third port 340 as well as between the port 320B and the second port 330. The second coupling 345 may also include multiplexing circuitry to multiplex signals received at the port 320B between the second port 330 and the third port 340. As an example, the port 320B and the third port 340 may each be implemented as a USB type port (e.g., a USB type A port, a USB type B port, a USB type C port, a USB mini port, or a USB micro port). Also, the second port 330 may be implemented using an interface standard that is able to receive a USB signal. In that case, the second coupling 345 may include a USB hub to provide USB based signals received at the port 320B to the second port 330 and the third port 340.

FIG. 4 illustrates an interface connector according to an example.

Referring to FIG. 4, an interface connector 400 includes a housing 410. Located within the housing 410 are a first port 420, a first coupling 425, a second port 430, a third port 440, and a second coupling 445. The housing 410, the first port 420, the first coupling 425, and the second port 430 are substantially similar to the housing 310, the first port 320, the first coupling 325, and the second port 330 described above with reference to FIG. 3 and a detailed description of these features will not be repeated for sake of brevity.

A third port 440 is positioned within the housing 410 for coupling with a peripheral component, such as the peripheral component 130 of FIG. 1. In the example of FIG. 4, the third port includes port 440A and port 440B. The ports 440A and 440B may be provided to support connection of a plurality of peripheral components, such as two or more of peripheral component 130 of FIG. 1. While FIG. 4 illustrates that the third port includes two ports 440A and 440B, it is to be understood that the third port may include three or more ports for connection to a plurality of peripheral components.

In the example of FIG. 4 in which the connector 400 includes ports 440A and 440B to connect to a plurality of peripheral components, two peripheral cables 131A and 131B and corresponding peripheral connectors 135A and 135B are similarly illustrated. The ports 440A and 440B may respectively receive peripheral connectors 135A and 135B for providing signals to the respective peripheral components. For example, signals exchanged with the peripheral components may include one or more of a video signal, an audio signal, a control signal, a data signal, a power signal, or the like. The third port 440 may be one or more of an OCuLink port, an HDMI port, a USB port, a displayport port, or the like in order to support the signals exchanged with the peripheral components.

The second coupling 445 is provided between the first port 420 and the third port 440 as well as between the first port 420 and the second port 430. In the example of FIG. 4, the second coupling is provided between the port 420B and the third port 440 as well as between the port 420B and the second port 430. The second coupling 445 may include a plurality of conductors to exchange signals between the port 420B and the third port 440 as well as between the port 420B and the second port 430. The second coupling 445 may also include multiplexing circuitry to multiplex signals received at the port 420B between the second port 430 and the third port 440. More specifically, the multiplexing circuitry may be provided to multiplex signals received at the port 420B between the second port 430, the port 440A, and the port 440B.

As an example, the port 420B, the port 440A, and the port 440B may each be implemented as a USB type port (e.g., a USB type A port, a USB type B port, a USB type C port, a USB mini port, or a USB micro port). Also, the second port 430 may be implemented using an interface standard that is able to receive a USB signal. In that case, the second coupling 445 may include a USB hub to provide USB based signals received at the port 420B to each of the port 440A, the port 440B, and the second port 430.

The connector 400 may also include converter circuitry 447. The converter circuitry 447 may be provided to convert signals having different standards into a desired standard for transmission. As an example, the ports 420B, 440A, and 440B may be implemented as USB type ports. In that case, one or more of the ports 420B, 440A, and 440B may be a USB 2.0 type port while one or more of the ports 420B, 440A, and 440B may be a USB 3.0 type port. In that case, it may be desired to convert a signal received through the USB type 2.0 port into a signal for transmission using the USB type 3.0 port. The converter circuitry 447 may receive a signal from the USB type 2.0 port, convert the received signal for transmission by the USB type 3.0 port, and provide the converted signal to the USB type 3.0 port. In the example of FIG. 4, it is illustrated that the converter circuitry 447 is separate from the second coupling 445. However, it is to be understood that the converter circuitry 447 may be implemented with the second coupling 445.

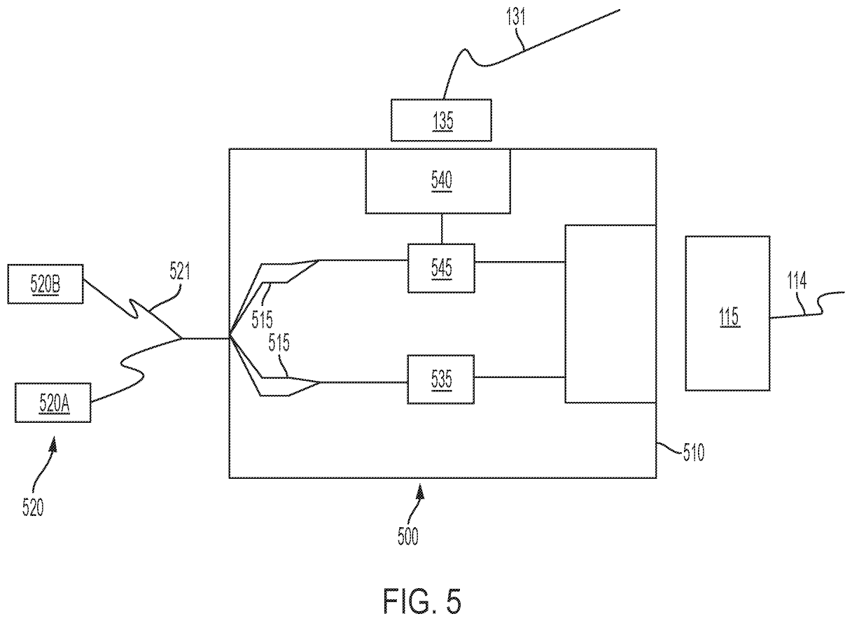

FIG. 5 illustrates a connecting device according to an example.

Referring to FIG. 5, a connecting device 500 includes a first connector housing 510, a second connector housing 520, and a cable 521.

The cable 521 is a multiconductor cable to exchange signals between a computing device (not shown) and an HMD device, and between the computing device and a peripheral component. In an example, signals exchanged with the HMD device and/or the peripheral component may include one or more of a video signal, an audio signal, a control signal, a data signal, a power signal, or the like. The cable 521 is physically coupled with the first connector housing 510 at a first end and physically coupled with the second connector housing 520 at a second end.

The first connector housing 510 includes a plurality of contacts 515, a first port 530, a first coupling 535, a second port 540, and a second coupling 545. The plurality of contacts 515 are located within the first connector housing 510 to respectively provide electrical connections with individual conductors of the cable 521.

The first port 530 is positioned within the first connector housing 510 for coupling with an HMD device, such as the HMD device 110 of FIG. 1. In that regard, the first port 530 may receive the local connector 115 coupled with the local communication cable 114 for exchanging signals with the HMD device 110. In an example, signals exchanged with the HMD device 110 may include one or more of a video signal, an audio signal, a control signal, a data signal, a power signal, or the like. The first port 530 may be one or more of an OCuLink port, an HDMI port, a USB port, a displayport port, or the like in order to support the first plurality of signals exchanged with the HMD device 110.

The first coupling 535 is provided between the plurality of contacts 515 and the first port 530. The first coupling 535 may include a plurality of conductors to exchange signals between one or more of the plurality of contacts 515 and the first port 530. Furthermore, the first coupling 535 may include a repeater or other circuitry to amplify or otherwise improve the quality of a signal received at the plurality of contacts 515. For example, the first coupling 535 may include re-driver circuitry to enhance the quality of a signal received at the plurality of contacts 515. The improved signal is output from the first coupling 535 and provided to the HMD device 110 through the first port 530, the local connector 115, and the local communication cable 114.

The second port 540 is positioned within the first connector housing 510 for coupling with a peripheral component, such as the peripheral component 130 of FIG. 1. In that regard, the second port 540 may receive the peripheral connector 135 coupled with the peripheral communication cable 131 for exchanging signals with the peripheral component 130. For example, signals exchanged with the peripheral component 130 may include one or more of a video signal, an audio signal, a control signal, a data signal, a power signal, or the like. The third port 540 may be one or more of an OCuLink port, an HDMI port, a USB port, a displayport port, or the like in order to support the signals exchanged with the peripheral component 130.

The second coupling 545 is provided between the plurality of contacts 515 and the second port 540. The second coupling 545 may include a plurality of conductors to exchange signals between one or more of the plurality of contacts 515 and the second port 540 as well as between one or more of the plurality of contacts 515 and the first port 530. The second coupling 545 may also include multiplexing circuitry to multiplex signals received at the plurality of contacts 515 between the first port 530 and the second port 540. As an example, the first port 530 and the second port 540 may each be implemented as a USB type port (e.g., a USB type A port, a USB type B port, a USB type C port, a USB mini port, or a USB micro port). Also, the cable 521 and the plurality of contacts 515 may be implemented using an interface standard that is able to receive a USB signal. In that case, the second coupling 545 may include a USB hub to provide USB based signals received at the plurality of contacts 515 to the first port 530 and the second port 540.

Although not illustrated in FIG. 5, the second port 540 may include a plurality of ports to exchange signals with two or more peripheral components. In that case, the multiplexing circuitry of the second coupling 545 may multiplex a signal received at the plurality of contacts 515 between the first port 530 and the plurality of second ports 540. Furthermore, the second coupling 545 may include converter circuitry to convert signals to desired standards for transmission.

The second connector housing 520 may include a housing 520A and a housing 520B according to a desired form factor or interface standard for transmission/reception of a desired signal. The forms of housings 520A and 520B may also be selected according to available types of connections at the computing device. As an example, the housing 520A may be implemented to support one or more of an audio signal, a video signal, a control signal, a data signal, or the like. In that case, the housing 520A may include an HDMI port, a displayport port, a DVI port, or the like. On the other hand, the housing 520B may provide an interface to support one or more of a control signal, data signal, a power signal, or the like. In that case, the housing 520B may include a USB 2.0 port, a USB 3.0 port, or the like. Further, the housing 520B may include a USB type A port, a USB type B port, a USB type C port, a USB mini port, a USB micro port, or the like.

Although the examples have been described with reference to the accompanying drawings, various changes and modifications may be made. For example, the relevant results may be achieved even when the described components such as systems, structures, and devices are coupled or combined in a different form than those described above or are replaced or substituted by other components or equivalents.

Therefore, the scope of the present disclosure should be defined not by the described examples alone, but by the appended claims and the equivalents thereof.

What is claimed is:

1. A connector to interface between a head-mounted display (HMD) device and a computing device, the connector comprising:
a housing;
a first port positioned within the housing to receive a first cable that is connectable to the computing device and to exchange a first plurality of signals between the computing device and the HMD device;
a second port positioned within the housing to receive a second cable that is connectable to the HMD device, the second port coupled with the first port to exchange the first plurality of signals between the computing device and the HMD device; and
a third port positioned within the housing to receive a third cable that is connectable to a peripheral device, the third port coupled with the first port to exchange a second plurality of signals between the computing device and the peripheral device.

2. The connector of claim 1, further comprising:
a multiplexing circuit positioned within the housing to multiplex a first data signal of the first plurality of signals exchanged between the first port and the second port with a second data signal of the second plurality of signals exchanged between the first port and the third port.

3. The connector of claim 2, wherein the multiplexing circuit comprises a universal serial bus (USB) hub.

4. The connector of claim 1,
wherein the first port comprises a high-definition multimedia interface (HDMI) port, a universal serial bus (USB) Type-A port, a mini-USB port, a micro-USB port, a USB type-C port, a displayport port, or a digital visual interface (DVI) port, and
wherein the second port comprises an optical-copper link (OCuLink) port.

5. The connector of claim 4 wherein the third port comprises one of a universal serial bus (USB) Type-A port, a mini-USB port, a micro-USB port, or a USB type-C port.

6. The connector of claim 1, wherein the first plurality of signals includes a first data signal, an audio signal, a video signal, and a power signal.

7. The connector of claim 6, wherein the second plurality of signals includes a second data signal and the power signal.

8. A connecting device to interface between a head-mounted display (HMD) device and a computing device, the connecting device comprising:
a cable including a first end and a second end;
a first connector housing including a plurality of contacts to couple to the first end of the cable;
a first port positioned within the first connector housing to receive a connection from the HMD device, the first port coupled with the plurality of contacts to exchange a first plurality of signals between the HMD device and the cable;
a second port positioned within the first connector housing to receive a connection from a peripheral device, the second port coupled with the plurality of contacts to exchange a second plurality of signals between the peripheral device and the cable; and
a second connector housing coupled to the second end of the cable to connect to the computing device and to exchange the first plurality of signals and the second plurality of signals with the computing device.

9. The connecting device of claim 8, further comprising:
a multiplexing circuit to multiplex a first data signal of the first plurality of signals with a second data signal of the second plurality of signals.

10. The connecting device of claim 9, wherein the multiplexing circuit comprises a universal serial bus (USB) hub.

11. The connecting device of claim 8, wherein the first port comprises an optical-copper link (OCuLink) port.

12. The connecting device of claim 11, wherein the second port comprises one of a universal serial bus (USB) Type-A port, a mini-USB port, a micro-USB port, or a USB type-C port.

13. The connecting device of claim 8, wherein the first plurality of signals includes a first data signal, an audio signal, a video signal, and a power signal.

14. The connecting device of claim 13, wherein the second plurality of signals includes a second data signal and the power signal.

15. A connector to interface between a head-mounted display (HMD) device, a peripheral device, and a computing device, the connector comprising:
a first optical copper link (OCuLink) port to receive an OCuLink connector from the HMD;
a second OCuLink port, coupled with the first OCuLink port, to receive an OCuLink connector from the computing device and to exchange a first set of signals between the HMD and the computing device; and
a mini universal serial bus (USB) port, coupled with the second OCuLink port, to receive a mini-USB connector from the peripheral device and to exchange a second set of signals between the peripheral device and the computing device.
